(19) United States
(12) Patent Application Publication
(10) Pub. No.: US 2025/0087929 A1
(43) Pub. Date: Mar. 13, 2025

(54) ELBOW CABLE CONNECTOR AND MAKING METHOD OF THE SAME

(71) Applicants: FOXCONN (KUNSHAN) COMPUTER CONNECTOR CO., LTD., Kunshan (CN); FOXCONN INTERCONNECT TECHNOLOGY LIMITED, Grand Cayman (KY)

(72) Inventors: Teng Huang, Shenzhen (CN); De-Jin Chen, Shenzhen (CN); He Chen, Zhengzhou (CN); Shih-Wei Hsiao, New Taipei (TW); Yu-San Hsiao, New Taipei (TW)

(21) Appl. No.: 18/884,401

(22) Filed: Sep. 13, 2024

(30) Foreign Application Priority Data
Sep. 13, 2023 (CN) 202311181354.6
Sep. 13, 2023 (CN) 202322494343.5

(51) Int. Cl. H01R 13/504; H01R 13/422; H01R 13/52; H01R 13/6597; H01R 43/02

(52) U.S. Cl. CPC H01R 13/504; H01R 13/4223; H01R 43/0221; H01R 13/5205; H01R 13/6597

(57) ABSTRACT

An elbow cable connector includes: a cable assembly comprising a head, an outer conductor extending forwards, an insulator received in the outer conductor, an inner conductor received in the insulator, a cable mechanically connected with the inner conductor and extending downwards, and a rear cover; and an outer shell surrounding the outer conductor, the head, and an upper end of the cable; wherein the head is of a die casting and has a fixing hole running forwards and a receiving groove opening rearwards and downwards, the outer conductor has a rear flange on a rear end thereof, the outer conductor goes across the fixing hole and the rear flange presses against a front face of the receiving groove, a rear part of the insulator and the upper end of the cable are received in the receiving groove, and the rear cover presses forward and seal the receiving groove.

### BACKGROUND OF THE INVENTION

### Field of the Invention

The present invention relates to an elbow cable connector and a making method of the same.

### Description of Related Arts

China Patent CN217281302U discloses a terminal assembly and a connector. The terminal assembly includes an insulator of an L-shape with a first insulator extending in a first direction and a second insulator extending along a second direction perpendicular to the first direction, a terminal fixed in the insulator, and a shielding shell of an L-shape and installed on an outside of the insulator. The shielding shell is formed with a plurality of shell parts assembled together. At least one of the shell parts is made by a stamping and forming method. Therefore, the manufacturing cost can be reduced and the size of the connector can be reduced. However, the strength of the connector is not enough when used in vehicle application or industrial field.

Therefore, it is desired to provide an improved elbow cable connector.

### SUMMARY OF THE INVENTION

An object of the present invention is to provide an elbow cable connector with an improved strength.

To achieve the above object, an elbow cable connector comprises: a cable assembly comprising a head, an outer conductor extending forwards, an insulator received in the outer conductor, an inner conductor received in the insulator, a cable mechanically connected with the inner conductor and extending downwards, and a rear cover; and an outer shell surrounding the outer conductor, the head, and an upper end of the cable; wherein the head is of a die casting and has a fixing hole running forwards and a receiving groove opening rearwards and downwards, the outer conductor has a rear flange on a rear end thereof, the outer conductor goes across the fixing hole and the rear flange presses against a front face of the receiving groove, a rear part of the insulator and the upper end of the cable are received in the receiving groove, and the rear cover presses forward and seal the receiving groove.

Other objects, advantages and novel features of the present invention will become more apparent from the following detailed description of the present embodiment when taken in conjunction with the accompanying drawings.

### BRIEF DESCRIPTION OF THE DRAWING

FIG. 1 is a perspective view of an elbow cable connector of an embodiment of the present invention;

FIG. 2 is a cross-sectional view of the cable connector in FIG. 1 along line A-A;

FIG. 3 is an exploded perspective view of the cable connector in FIG. 1;

FIG. 4 is another view of the cable connector in FIG. 3;

FIG. 5 is a front plan view of the cable connector in FIG. 4 to show how the cable connector are welded by laser, wherein a positioning member, a lower waterproof ring and a fixing member are removed;

FIG. 6 is a further exploded perspective view of the cable connector in FIG. 3, wherein the positioning member, the lower waterproof ring and the fixing member are removed;

FIG. 7 is another view of the cable connector in FIG. 6;

FIG. 8 is a perspective view of the cable assembly assembled in a first shell in FIG. 7;

FIG. 9 is an exploded perspective view of the waterproof ring and the first shell in FIG. 7;

FIG. 10 is an exploded perspective view of the cable assembly in FIG. 7;

FIG. 11 is an exploded perspective view of the cable assembly in FIG. 10, wherein an outer conductor is assembled in a head;

FIG. 12 is another view of the cable assembly in FIG. 11;

FIG. 13 is an exploded perspective view of the cable assembly in FIG. 11, wherein an insulator is assembled in the head;

FIG. 14 is an exploded perspective view of the cable assembly in FIG. 13, wherein the inner conductor with the cable is assembled in the head;

FIG. 15 is a perspective view of the cable assembly in FIG. 14, wherein a foldable portion of the insulator bends to the head.

### DETAILED DESCRIPTION OF THE PREFERRED EMBODIMENT

Reference will now be made in detail to the preferred embodiments of the present invention.

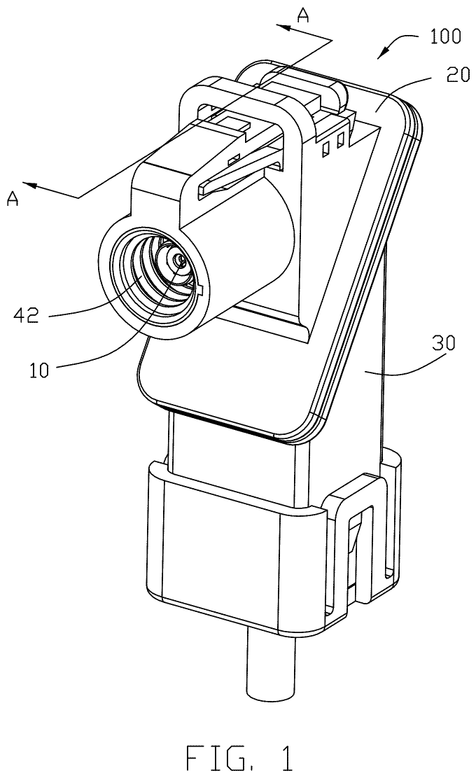

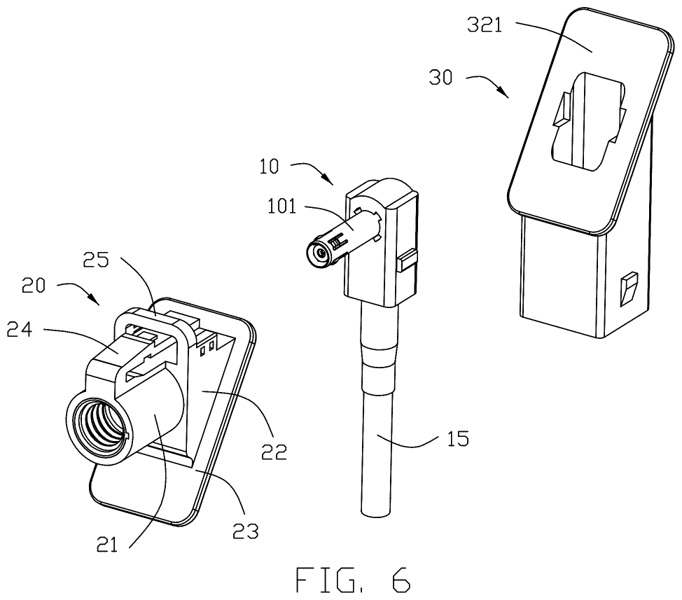

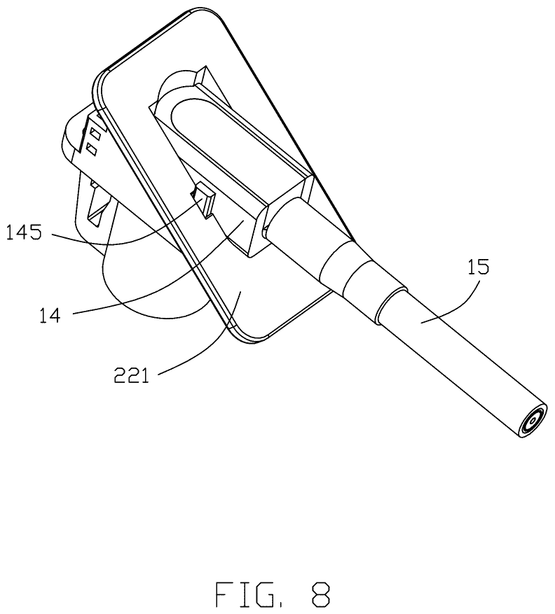

As shown in FIGS. 1-8, an elbow cable connector 100 is illustrated. In this embodiment, the cable connector 100 is a type of a waterproof Fakra cable connector. The cable connector 100 comprises a cable assembly 10, a first shell 20, a second shell 30, a front water-proof ring 42 and a lower water-proof ring 43 for water proof.

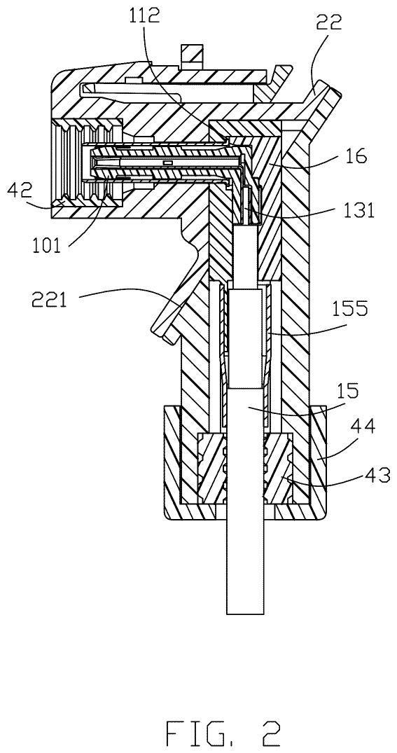

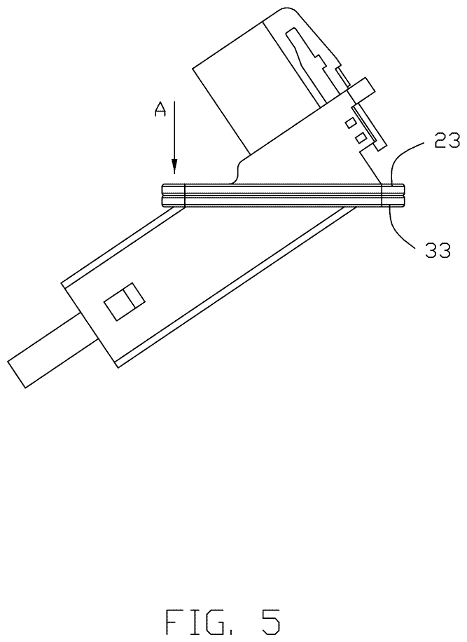

Referring to FIGS. 1-8 and FIG. 10, the cable assembly 10 comprises an outer conductor 11, an inner conductor 13 and a cable 15 mechanically and electrically connected with the inner conductor 13. The outer conductor 11 and the inner conductor 13 commonly forms a mating portion 101 which is inserted with a mating electrical connector (not shown). The mating portion 101 extends in a horizontal direction while the cable 15 extends in an upright direction, so that the mating portion 101 and the cable 15 form an L-shaped structure, to shape this elbow cable connector. The specific structure and assembling method will be described hereinafter. The first shell 20 is sleeved outside the mating portion 101, the second shell 30 is sleeved outside the cable 15, the two shells are fixed with each other to form a complete outer shell 20A. The first and second shells have mounting surfaces 221, 321 which are confronted and fixed with each other, and the cable 15 obliquely passes through the mounting surface 221, 321, as clearly shown in FIG. 2. The first shell 20 and the second shell 30 are made distinctly, and inclined to each other, so that it is convenient to assemble and fix the connector. The first shell 20 is made of an insulating material with a property of light transmission, such as PBT-I-GF30 which has a light transmittance of 90%. The second shell 30 is made of an insulating material and has no light-transmission property. It is convenient for the first and second shells to be fixed by laser spot welding. The first and second shells, each has a flange 23, 33 around the mounting face. As clearly shown in FIG. 5, the laser beam A is irradiated on the flange 23 of the first shell 20, the light-transmitting material of the first shell 20 allows the laser beam A to pass therethrough, the second shell 30 can absorb the laser beam to generate heat, so that the second shell 30 and the first shell 20 are fused with each other and fixed after cooling. In this way, the flanges 22, 32 are fixed by a circle of laser spot welding, which can satisfy holding and waterproof functions. The width of the laser spot welding can be about 0.5 mm.

The first shell 20 includes a base portion 22 and a mating tube 21 extending horizontally from the base portion 22, and the base portion 22 has a rear surface 221 inclined downward. A mating face of the connector in a mating direction or the horizontal direction is defined as a front end. The second shell 30 is substantially a rectangular tubular structure, which has an upper surface 321 inclined upward, and the rear surface 221 of the base portion 22 and the upper surface 31 of the second shell 30 form the mounting surfaces 221, 321. The rear surface 221 is disposed at an angle of 45 degrees with the mating tube 21. The base portion 22 has a flange 23 circled around the mounting surface 221, the second shell 30 has a flange 33 circled around the mounting surface 321, the flanges 23, 33 of the first and second shells are propped against each other and fixed together. The flanges 22, 33 are rectangular viewed in a front to back direction or the mating direction.

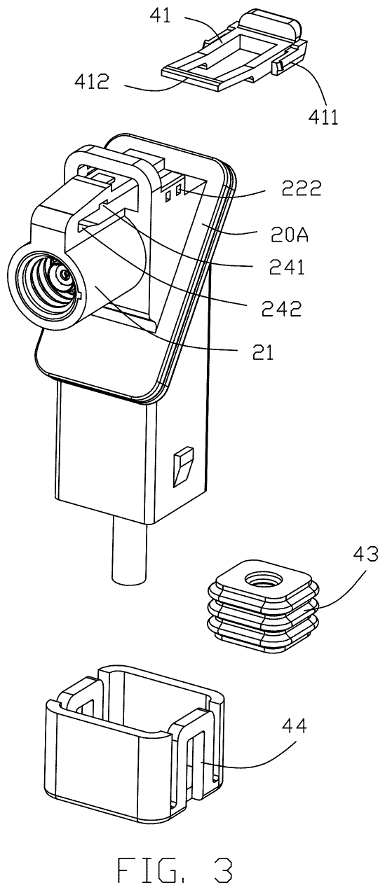

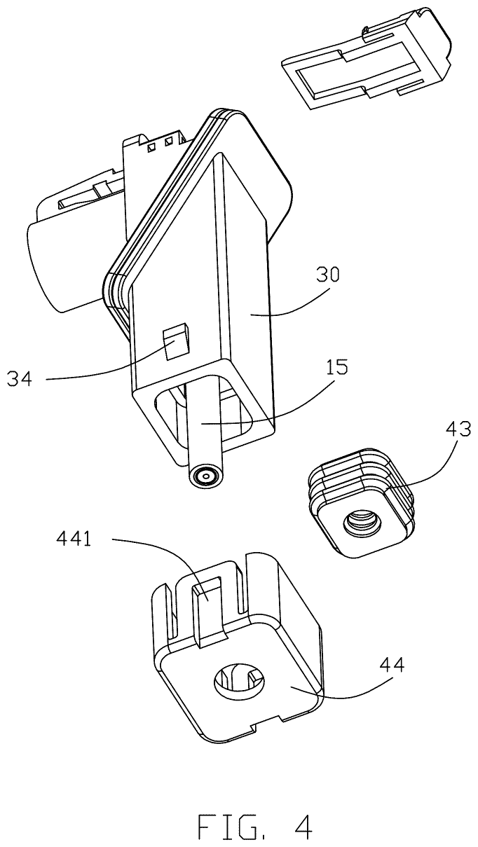

The first shell 20 has a locking arm 24 extending rearward from the front end of the mating tube 21 thereof and a bridge portion 25 across the base portion 22 perpendicular the mating direction. The locking arm 24 extends rearward through the bridge portion 25. Referring to FIGS. 3-4, a positioning member 41 is mounted on the base portion 22, the locking arm 24 has a stopping recess 241 at a lower surface thereof and a gap is defined between the locking arm 24 and the mating tube 21 so as to form a stopping gap 242. The positioning member 41 cooperates with the stop recess 241 and the stop gap 242 to realize a locking function. The positioning member 41 has a pair of mounting arm 411 located at two sides thereof, and a front beam 412 at the front end thereof. The base portion 22 has two mounting holes 222 at each side thereof, the mounting arms 411 are assembled in the mounting holes 222. The front beam 412 abuts against the stop recess 241 to prevent the positioning member 41 from moving forward improperly. During the connector is inserted with the mating connector, the locking arm 24 is pushed downwards to drive the two sides of the front beam 412 to move downwards, so that the front beam 412 moves downwards to separate from the stopping recess 241 so that a user can move the positioning member 41 forwards until the front beam 412 is contained in the stopping gap 242. Therefore, the locking arm 24 cannot move downward, preventing the improper downward movement of the locking arm 24.

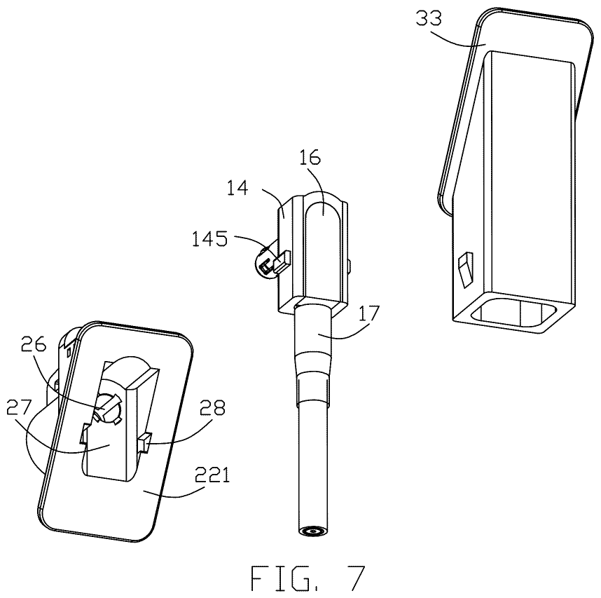

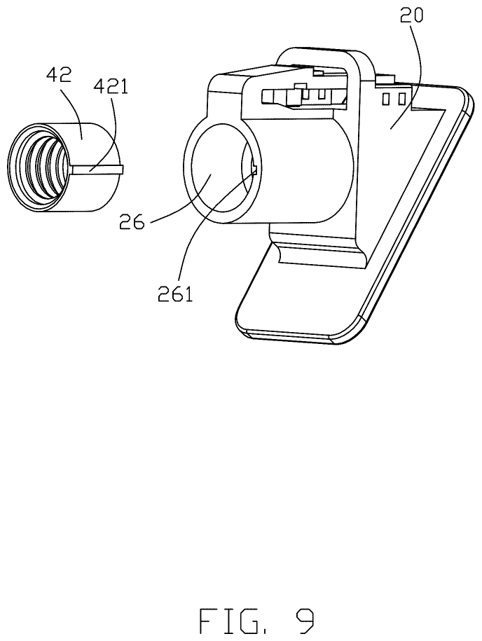

Referring to FIGS. 7-9, the first shell 20 has a passage 26 penetrating thereof in the mating direction and a mounting cavity 27 through the rear surface 221 thereof. The mating portion 101 is inserted in the passage 26, a head 14 of the cable assembly 10 is fixed in the mounting cavity 27. The head 14 has ribs 145 at two sides thereof, the ribs 145 are correspondingly fixed in fixing recesses 28 defined at opposite side of the mounting cavity 27. The specific structure of the head 14 will be described below. At the same time, the front waterproof ring 42 is installed in the front of the passage 26, and the front waterproof ring 42 can also be integrally formed in the first shell 20 by injection molding. After the mating connector is inserted, the front water-proof ring 42 can perform a water-proof effect between the two connectors. The front waterproof ring 42 has a mounting rib 421 extending in the mating direction, the mounting rib 421 is matched in the groove 261 in the passage 26, so as to prevent the front waterproof ring 42 from rotating and moving. As shown in FIG. 4, the lower waterproof ring 43 is further set between the second shell 30 and the cable 15, the fixing member 44 is buckled on an outside of the second shell 30. The fixing member 44 is installed on the lower end of the second shell 30, the buckling hole 441 on the fixing member 44 is fixed with a block 34 on the second shell 30 so as to assemble the lower waterproof ring 43 and the second shell 30 together.

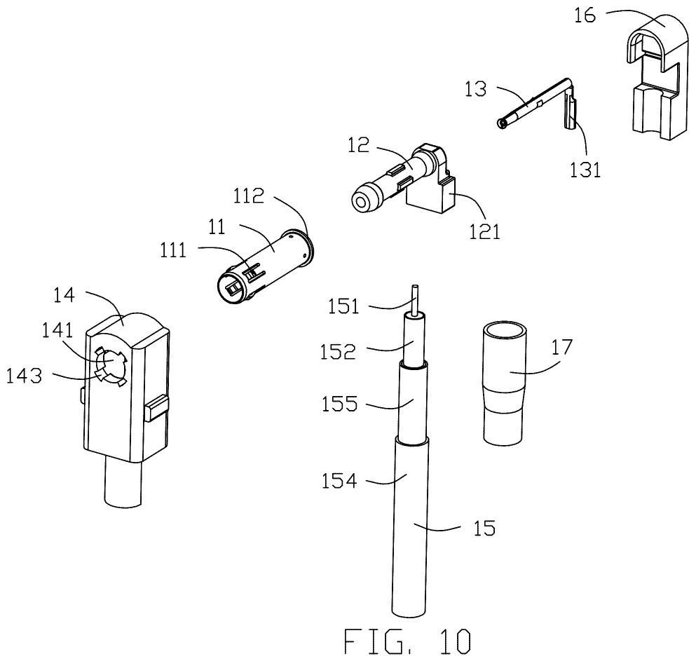

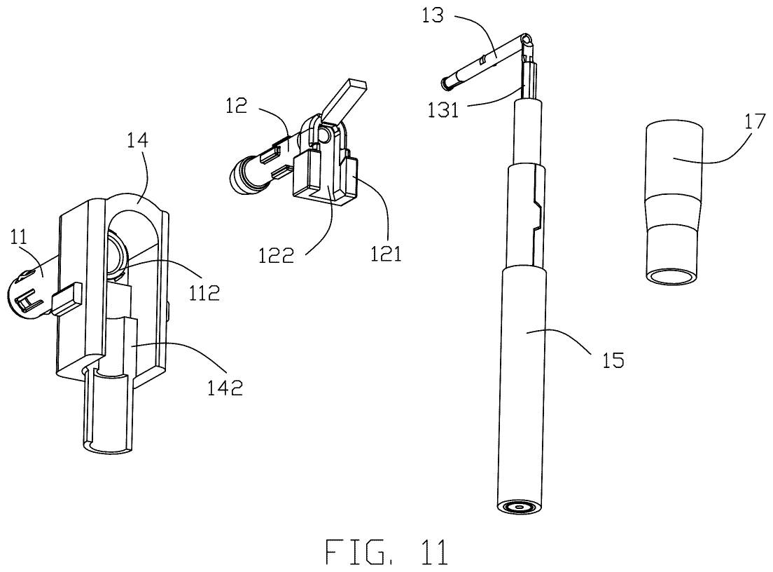

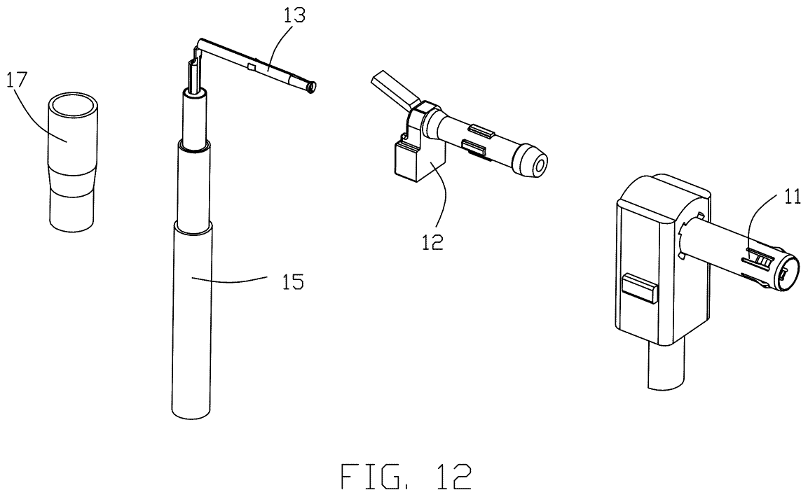

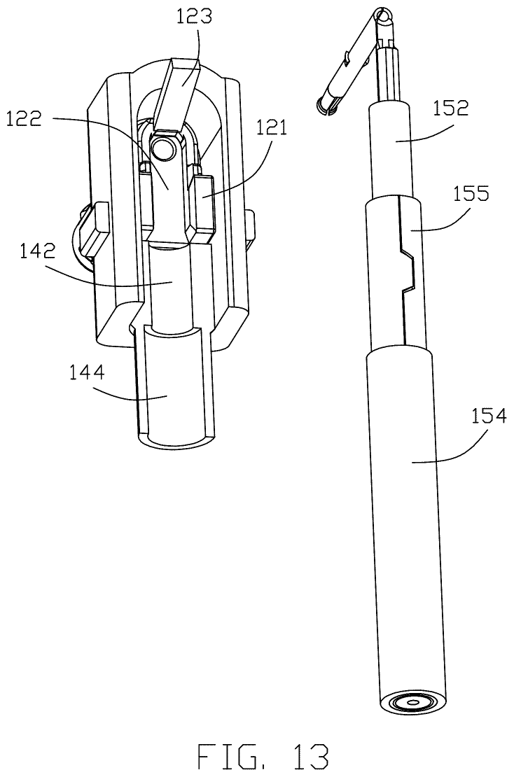

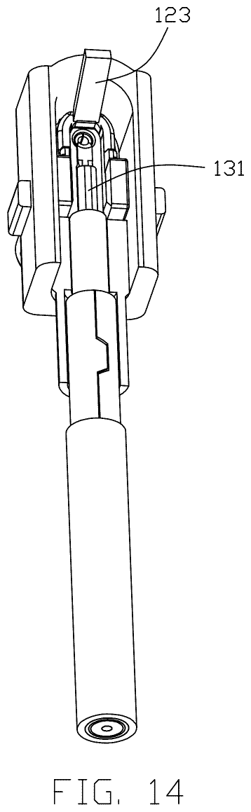

As shown in FIGS. 10-11, the cable assembly 10 includes the tubular outer conductor 11, an insulator 12, the inner conductor 13, the head 14, the cable 15, and the rear cover 16. The head 14 and the rear cover 16 are made of a conductive material and have a shielding function. The head provides a base function to get an L shape of the elbow cable connector with improved strength. In this embodiment, the head 14 is of an upright shape. Referring to FIGS. 12-15, a making method of the cable assembly 10 is described hereinafter.

In a first step, the outer conductor 11 is assembled to the head 14. The head 14 has a fixing hole 141 penetrating forwards and a receiving groove 142 opening downwards and rearward, the outer conductor 11 goes forwards through the fixing hole 141 and the rear end of the outer conductor 11 is fixed in the head 14. The outer conductor 11 has a plurality of fingers 111 located close to a front end thereof and protruding outward, and has is a rear flange 112 at a rear end thereof. The outer conductor 11 passes through the fixing hole 141 until the rear flange 112 props against the front face of the receiving groove 142. The fixing hole 1 has a plurality of notches 143 at an inside thereof, the fingers 111 pass through the notches 143 during the insertion of the outer conductor 11.

In a second step, the insulator 12 is inserted forward into the outer conductor 11. The insulator 12 includes a horizontal portion inserted into the outer conductor 11, and an upright portion 121 extending downwards and received in the receiving groove 142. The upright portion 121 has a locating groove 122 opening rearwards and downwards.

In a third step, the inner conductor 13 connected with the cable 15 in an L shape is assembled to the head 14. In the embodiment, a tail portion 131 of the inner conductor 13 bends downwards, the tail portion and an exposed core 151 of the cable 15 are connected together by riveting firstly. Then the inner conductor 13 is inserted forward into the insulator 12, the horizontal portion is forward inserted into the insulator 12, and the tail portion 131 with the exposed core 151 is located in the positioning groove 122. The cable 15 comprises the core 151, an insulating layer 152, a braided layer 153, and an outer insulating layer 154. The upper end of cable 15 is skinned to expose the exposed core 151, the exposed insulating layer 152, the exposed braided layer 153. A metal ring 155 can be further sleeved outside the braided layer 153, then the front end of the braided layer 153 is folded to weld with the braided layer, for increasing the strength of the cable. Alternatively, the braided layer 153 can exist without the metal ring. The receiving groove 142 is step-shaped and matches the exposed upper end of the cable 15. The head 14 has a supporting portion 144 extends downward. The supporting portion 144 has a shape matching with the half of the cable 15. The exposed braided layer 153 is located at the supporting portion 144. The insulating layer 152 is placed in the receiving groove 142. Alternatively, the inner conductor 13 can also be inserted into the insulator 12, and then the exposed core 151 of the cable 15 is connected to the tail portion 131 of the inner conductor 13. A foldable portion 123 of the insulator 12 bends to press and lock in the positioning groove 122 of the insulator 12, so as to fix the tail portion 131 and the exposed core 151.

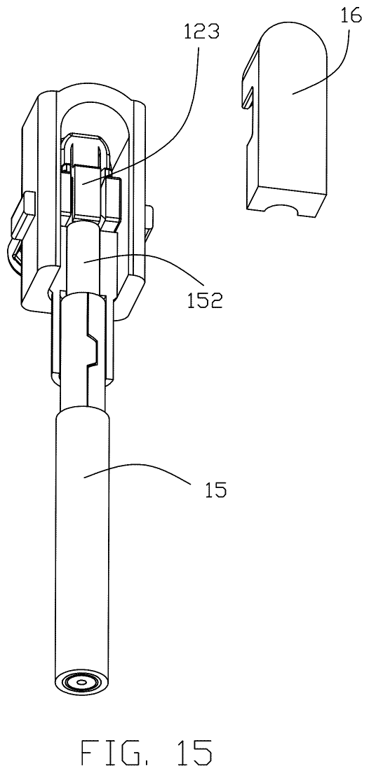

In a fourth step, the rear cover 16 is assembled in the receiving groove 142 of the head 14, so as to seal the head at a rear end. The rear cover 16 presses forward against the rear flange 112 of the outer conductor 11. Finally, a metal tube 17 can be added, the metal tube 17 is sleeved at the junction of the cable 15 and the head 14 by means of arc bending and riveting, so as to enhance the drawing strength of the cable. As shown in FIG. 10 and FIG. 15, the head 14 and the rear cover 16 are of die casting for increasing the strength of the connector and simplifying the making method of the connector, the structure of the front surface of the rear cover 16 is matched with the receiving groove 142 and the locating groove 122 for completely shielding. As shown in FIG. 2, the rear cover 16 abuts against the rear flange 112 of the outer conductor 11 to prevent the outer conductor 11 from moving backwards. In this embodiment, the outer conductor 11 and the head 14 are separately manufactured and assembled, which can ensure that the outer conductor has a complex structure of fingers, and also can ensure that the head in a die casting has enough strength.

Although the present invention has been described with reference to particular embodiments, it is not to be construed as being limited thereto. Various alterations and modifications can be made to the embodiments without in any way departing from the scope or spirit of the present invention as defined in the appended claims.

1. An elbow cable connector comprising:
a cable assembly comprising a head, an outer conductor extending forwards, an insulator received in the outer conductor, an inner conductor received in the insulator, a cable mechanically connected with the inner conductor and extending downwards, and a rear cover; and
an outer shell surrounding the outer conductor and the head and an upper end of the cable;
wherein the head is of a die casting and has a fixing hole running forwards and a receiving groove opening rearwards and downwards, the outer conductor has a rear flange on a rear end thereof, the outer conductor goes across the fixing hole and the rear flange presses against a front face of the receiving groove, a rear part of the insulator and the upper end of the cable are received in the receiving groove, and the rear cover presses forward and seal the mounting cavity.

2. The elbow cable connector as claimed in claim 1, wherein the rear cover is of a die casting.

3. The elbow cable connector as claimed in claim 1, wherein the rear cover presses forward against the rear flange.

4. The elbow cable connector as claimed in claim 1, wherein the outer conductor has a plurality of fingers near a front end thereof, the fixing hole has corresponding notches at an inside thereof, the fingers protrude outward and go across the notches when the outer conductor is inserted forward through the fixing hole.

5. The elbow cable connector as claimed in claim 1, wherein the insulator has an upright portion received in the receiving groove and a positioning groove opening rearwards and downwards, the inner conductor has a tail portion bending downwards, and the tail portion is soldered with an exposed core of the upper end of the cable and commonly received in the positioning groove.

6. The elbow cable connector as claimed in claim 5, wherein the rear cover is retained in the receiving groove.

7. The elbow cable connector as claimed in claim 1, wherein the outer shell comprises a first shell and a second shell assembled together, the first shell is made of an insulating material with a property of light transmission, and the second shell is made of an insulating material and has no light-transmission property.

8. The elbow cable connector as claimed in claim 7, wherein the first shell is sleeved outside the outer conductor and a front part of the head, and the second shell is sleeved outside a rear part of the head and the upper end of the cable.

9. The elbow cable connector as claimed in claim 8, wherein the first shell and the second shell are fixed by laser spot welding.

10. The elbow cable connector as claimed in claim 8, wherein the first shell and the second shell have mounting surfaces confronted and fixed with each other, and the cable obliquely passes through the mounting surface.

11. A making method of an elbow cable connector, comprising the steps of:
providing an outer conductor having a rear flange and a head having a fixing hole and a receiving groove opening rearwards and downwards, inserting the outer conductor forwards across the fixing hole to retain the rear flange inside the head;
providing an insulator having an upright portion with a positioning groove, inserting the insulator portion forward into the outer conductor so the upright portion is received in the receiving groove;
providing an inner conductor having a tail portion bending downwards, inserting the inner conductor forwards into the insulator so the tail portion is received in the positioning portion;
assembling a rear cover in and retained with the receiving groove to seal a rear end of the head.

12. The making method as claimed in claim 11, wherein the step of inserting the inner conductor comprises connecting the tail portion with an exposed core of a downward extending cable.

13. The making method as claimed in claim 12, further comprising folding a foldable portion of the insulator to press against the tail portion and the exposed core of the cable between the step of inserting the inner conductor and the step of assembling the rear cover.

14. An elbow cable connector comprising:
a cable assembly comprising a head extending downwards, an outer conductor extending forwards, an insulator received in the outer conductor, an inner conductor received in the insulator, a cable mechanically connected with the inner conductor and extending downwards, and a rear cover; and
wherein the head is of a die casting and has a fixing hole running forwards and a receiving groove opening rearwards and downwards, the outer conductor has a rear flange, and the rear cover presses forward against the rear flange and seal the receiving groove.
